(19) United States
(12) Patent Application Publication
(10) Pub. No.: US 2008/0294851 A1
(43) Pub. Date: Nov. 27, 2008

(54) METHOD, APPARATUS, COMPUTER PROGRAM PRODUCT, AND SYSTEM FOR MANAGEMENT OF SHARED MEMORY

(75) Inventors: Daniel Wernet, Bochum (DE); Dirk Tiegelbekkers, Essen (DE); Erwin Hemming, Herne (DE); Franziskus Bauer, Koln (DE); Oliver Luert, Bochum (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/753,766

(22) Filed: May 25, 2007

(51) Int. Cl. G06F 12/00

(52) U.S. Cl. 711/147

(57) ABSTRACT

A system for providing management of shared memory for concurrent access is provided. The system includes a hardware element, a software element, and a memory that is accessible by the hardware and software elements. The memory includes control data that provides logical information describing the structure of the memory and the location of data within the memory. The software element may be executed to cause the control data to be written/updated to reflect alterations to the memory. By accessing the control data of the memory, the hardware element is able to identify a location in the memory to which to write data. In this way, the hardware element may write data to the memory without interacting with the software element while writing data. An indicator may also be provided to direct the hardware element to a location of the memory to which to write data.

### FIELD OF THE INVENTION

Embodiments of the present invention relate generally to management of memory access and, more particularly, relate to an apparatus, method, computer program product, and system for managing shared memory for concurrent access.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, hardware and software improvements for electronic communications devices are continually released. Hardware typically includes the physical components of electronic communications devices. Software may typically be embodied as computer executable instructions that are stored in a memory and which, when executed, perform a function according to the instructions.

In many situations, both software and hardware blocks may share, or at least share the ability to access, the same memory. In such situations, it is common for the software to manage access to the memory. For example, a device such as a mobile terminal may include a shared memory and control software such as device driver software that may manage access to the shared memory. Dedicated hardware such as a peripheral device may be able to access the shared memory to, for example, write information to the shared memory. However, the ability of the dedicated hardware to access the shared memory is typically controlled by the control software. As such, in a typical arrangement, if the dedicated hardware attempts to write information to the shared memory, the dedicated hardware must communicate with the control software to determine where to write the information within the shared memory. For example, the dedicated hardware may interrupt a processing element, such as an embedded processor, associated with the control software or engage the processing element to poll memory areas of the shared memory and inform the dedicated hardware of locations to which the dedicated hardware may write information. Accordingly, performance of the control software in executing other functions may be reduced by the interruption or by the consumption of processing power for use in identifying memory areas for the dedicated hardware to use.

Accordingly, there may be an existing need to improve management of shared memory for concurrent access by hardware and software.

### BRIEF SUMMARY OF THE INVENTION

A method, computer program product, apparatus and system are therefore provided that improve management of shared memory for concurrent access by hardware and software. For example, hardware may be enabled to access memory without interrupting software or consuming software processing power. In order to accomplish this, for example, hardware may be enabled to determine areas of the shared memory to which the hardware may write without communication with the software prior to the writing by the hardware with respect to the writing operation. In this regard, it should be understood that although communication may not be necessary between the hardware and the software with respect to the writing operation prior to the writing operation itself, there may be communications between the hardware and the software at various times to update management information associated with the shared memory or to set up conditions such that for a next write operation, the next write operation, whenever it may occur, can be performed without requiring the hardware to interrupt the software to engage in memory access management. Accordingly, efficiency and performance of the software may not be hindered by the consumption of processing power associated with managing access to the shared memory, while still enabling the hardware to access the memory in an efficient manner.

In some exemplary embodiments, a method and computer program product for managing shared memory for concurrent access are provided. The method and computer program product access, using a hardware element, control data stored in a memory that is accessible to at least the hardware element and a software element. Based on the control data, a location of the memory to which the hardware element is able to write data is identified, and data is written to the identified location from the hardware element without interaction with the software element while writing data to the identified location.

Accessing control data may include accessing logical information distributed among a number of locations of the memory to identify at least one portion of the memory to which the hardware element is able to write data. Alternatively, the logical information may be disposed in a single location of the memory. In some embodiments, accessing the control data may include accessing logical information that has been updated by the software element in response to previous alterations to the memory.

In some cases, an indicator indicative of a next location of the memory to which the hardware element is able to write during subsequent writing operations may be updated. The indicator may be accessible to at least the hardware element and the software element. Updating the indicator may include copying at least a portion of the control data to the hardware element. Furthermore, writing data may include deleting data from the memory.

In another exemplary embodiment, an apparatus for providing management of shared memory for concurrent access is provided. The apparatus includes a shared memory having a first portion and a second portion. The first portion is configured to enable writing access by at least a software element and a hardware element, and the second portion is configured to enable writing access only by the software element. The second portion includes control data readable by the hardware element for directing the hardware element to which location of the first portion of the memory the hardware element is able to write data without interaction with the software element. The apparatus may include the software element stored in the memory and configured, upon execution, to write control data to the second portion in response to the hardware element writing data to the first portion.

The first and second portions may each be distributed throughout the memory. The first portion may be distributed throughout the memory to define a number of memory pages, and the second portion may be distributed to provide corresponding control data for each memory page. Also, in some embodiments, the second portion includes an indicator indicative of a next location of the first portion of the memory to which the hardware element is able to write during subsequent writing operations. The indicator may be updated following each writing operation, or the indicator may be updated periodically.

In another exemplary embodiment, an apparatus for providing management of shared memory for concurrent access is provided that includes a hardware element. The hardware element has a processor configured to access control data stored in a memory identifying a location in the memory to which to write data. The hardware element is configured to write data to the identified location of the memory that is accessible to at least the hardware element and a software element without interaction with the software element while writing data to the identified location. The hardware element may include a Direct Memory Access (DMA) controller. Furthermore, the hardware element may be configured to access an indicator including at least a portion of the control data indicative of a next location of the memory to which the hardware element is able to write.

In another exemplary embodiment, an apparatus for providing management of shared memory for concurrent access is provided that includes means for accessing control data stored in a memory that is accessible to at least a hardware element and a software element. The apparatus also includes means for identifying, based on the control data, a location of the memory to which the hardware element is able to write data, as well as means for writing data to the identified location from the hardware element without interaction with the software element while writing data to the identified location. The apparatus may further include means for updating an indicator indicative of a next location of the memory to which the hardware element is able to write during subsequent writing operations, wherein the indicator is accessible to at least the hardware element and the software element.

In another exemplary embodiment, a system for providing management of shared memory for concurrent access is provided. The system includes a hardware element, a software element, and a memory. The software element is configured, upon execution, to communicate with the hardware element. The memory is configured to store control data and also to be accessible to at least the hardware element and the software element. The hardware element is configured to access the control data, to identify, based on the control data, a location of the memory to which to write data, and to write data to the identified location without interaction with the software element while writing data to the identified location.

In some cases, the hardware element may include a DMA controller. The hardware element may be configured to access control data distributed among a number of locations of the memory. Also, the hardware element may be configured to delete data from the memory.

The software element may be configured, upon execution, to update the control data in response to previous alterations to the memory. The software element may further be configured, upon execution, to update an indicator indicative of a next location of the memory to which the hardware element is able to write during subsequent writing operations, and the indicator may be accessible to the hardware element.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram showing a system including a hardware element and a software element having access to a shared memory according to an exemplary embodiment of the present invention;

FIG. 4 is a schematic block diagram of a computing device according to an exemplary embodiment of the present invention;

FIG. 5 illustrates a block diagram showing a memory page according to an exemplary embodiment of the present invention; and

FIG. 6 is a flowchart according to an exemplary method of managing shared memory for concurrent access according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

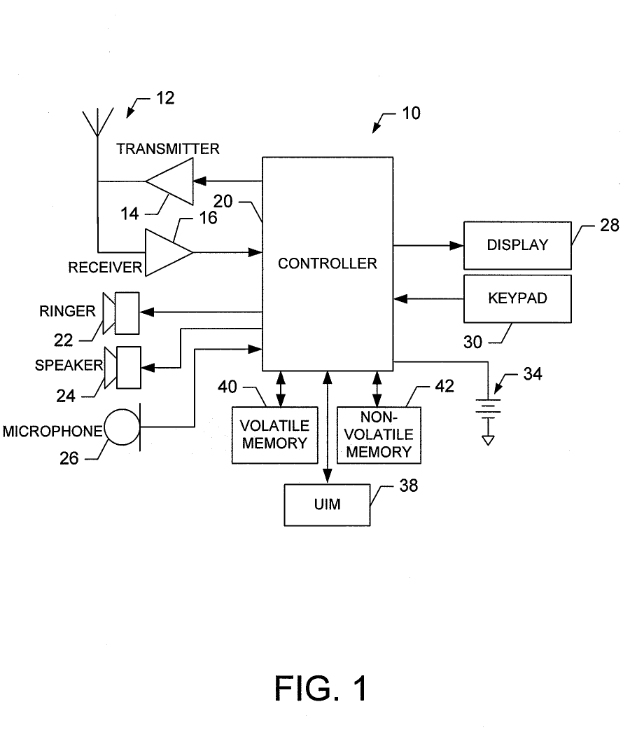

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

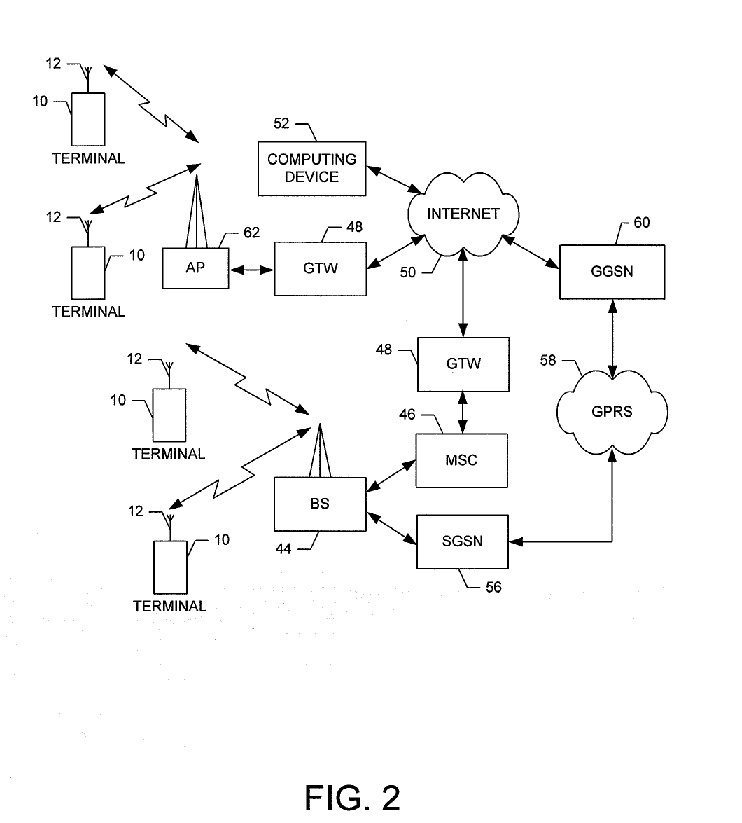

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing device 52 or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing device 52 may be coupled to the mobile terminal 10 via the Internet 50, SGSN 56 and GGSN 60. In this regard, devices such as the computing device 52 may communicate with the mobile terminal 10 across the SGSN 56, GPRS core network 58 and the GGSN 60. By directly or indirectly connecting mobile terminals 10 and the other devices (e.g., computing device 52) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing device 52 and/or any of a number of other devices, to the Internet 50, the mobile terminals 10 can communicate with one another, the computing device, etc., to thereby carry out various functions of the mobile terminals 10, such as to transmit data, content or the like to, and/or receive content, data or the like from, the computing device 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing device 52 across the Internet 50, the mobile terminal 10 and computing device 52 may be coupled to one another and communicate in accordance with, for example, RF, BT, IrDA or any of a number of different wireline or wireless communication techniques, including LAN, WLAN, WiMAX, UWB techniques and/or the like. One or more of the computing devices 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals or peripherals). Like with the computing devices 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1 and a network device of the system of FIG. 2 in order to execute applications for establishing communication between the mobile terminal 10 and other mobile terminals, for example, via the system of FIG. 2. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a network device or other device accessible to the communication device.

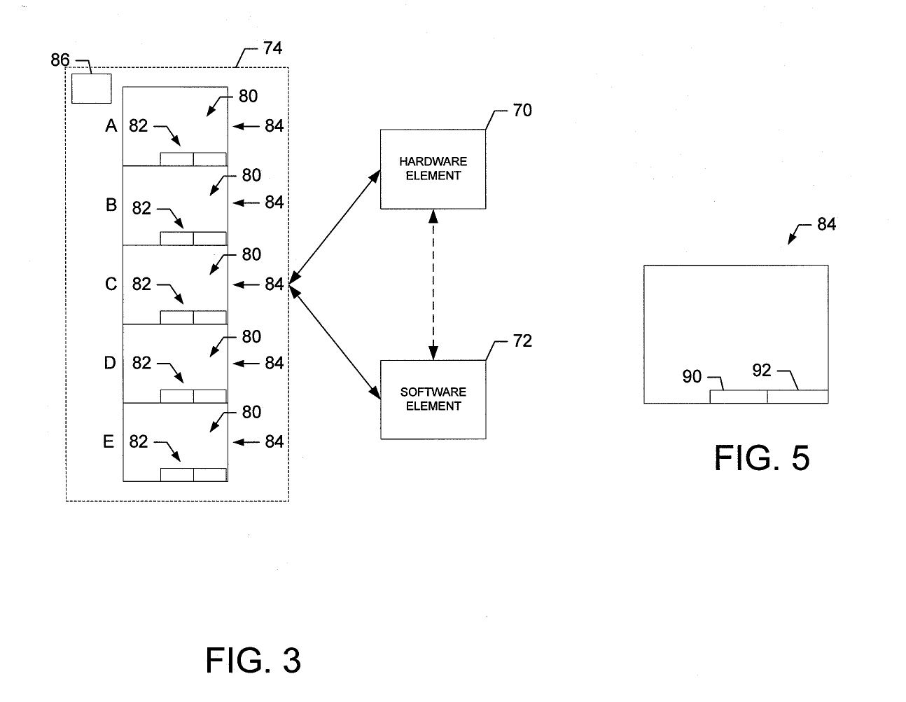

An exemplary embodiment of the invention will now be described with reference to FIG. 3, in which certain elements of a system are displayed. The system of FIG. 3 may be employed, for example, on the mobile terminal 10 of FIG. 1 or the network devices of FIG. 2. However, it should be noted that the system of FIG. 3, may also be employed on a variety of other devices, both mobile and fixed, and therefore, the present invention should not be limited to application on devices, such as the mobile terminal 10 of FIG. 1 or the network devices of FIG. 2, such as the computing device 52.

Referring now to FIG. 3, a block diagram is provided showing a system including a hardware element 70 and a software element 72 having access to a shared memory 74 according to an exemplary embodiment of the present invention. The hardware element 70 may be any hardware device which needs, at least occasionally, to access memory and may include, for example, at least a processing element or controller. The software element 72 may include any software embodied in computer readable code that is capable upon execution of controlling access to the memory 74.

In one exemplary embodiment, a mobile terminal 10, such as shown in FIG. 1, includes a shared memory, such as volatile memory 40, as well as the software element 72, such as device driver software that typically manages access to the shared memory upon execution by the controller 20. The software element 72 in this embodiment may be stored in the non-volatile memory 42. In this exemplary embodiment, a computing device 52 may include the hardware element, such as a direct memory access (DMA) controller, a processor, or the like. The computing device may be in communication with the mobile terminal, either via a network, such as depicted in FIG. 2, or directly via a wired or wireless connection. As such, the computing device may be considered a peripheral by the mobile terminal in regards to its efforts to access the shared memory. As described below, the hardware element is configured to directly access memory without engaging the software element, thereby conserving the processing resources of the mobile terminal that conventionally would have been at least partially consumed servicing the memory requests by the computing device.

Although the hardware and software elements are described above as being embodied by two different devices, a single device may include both the hardware and software element in other embodiments. Additionally, the mobile terminal may include the hardware element and serve as a peripheral with the computing device including the shared memory and the software element in other embodiments, with still other embodiments including the hardware and software elements in one or two computing devices which are not mobile terminals.

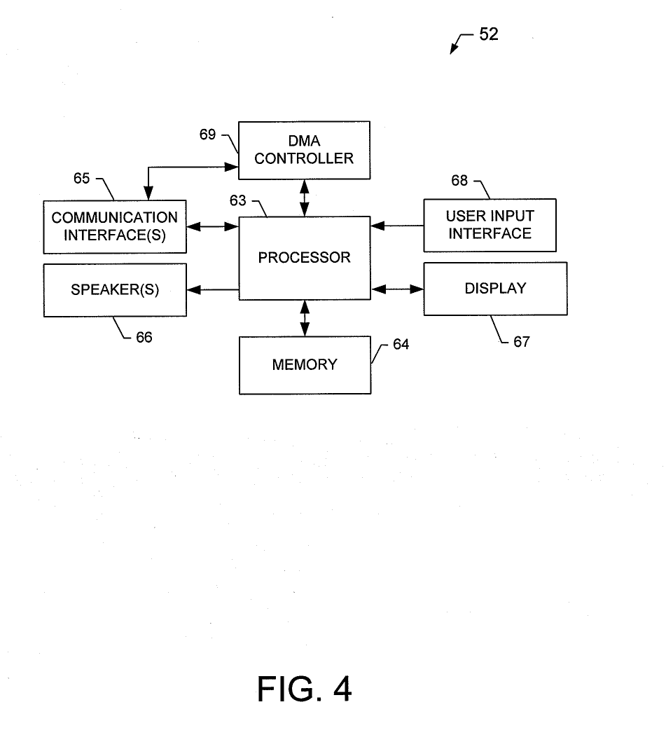

Referring now to FIG. 4, a block diagram of a computing device (fixed or mobile) 52 is shown in accordance with one embodiment of the present invention. The computing device 52 includes various means for performing one or more functions in accordance with exemplary embodiments of the present invention, including those more particularly shown and described herein. It should be understood, however, that one or more of the computing devices may include alternative means for performing one or more like functions, without departing from the spirit and scope of the present invention. More particularly, for example, as shown in FIG. 4, the computing device 52 can include a processor 63 connected to a memory 64. The memory can comprise volatile and/or non-volatile memory, and typically stores content, data or the like. For example, the memory typically stores content transmitted from, and/or received by, the computing device 52. Also for example, the memory 64 typically stores applications, instructions or the like for the processor 63 to perform steps associated with operation of the computing device in accordance with embodiments of the present invention.

In addition to the memory 64, the processor 63 can also be connected to at least one interface or other means for displaying, transmitting and/or receiving data, content or the like. In this regard, the interface(s) can include at least one communication interface 65 or other means for transmitting and/or receiving data, content or the like. As explained below, for example, the communication interface(s) 65 can include a first communication interface for connecting to a first network, and a second communication interface for connecting to a second network. In addition to the communication interface(s), the interface(s) can also include at least one user interface that can include one or more earphones and/or speakers 66, a display 67, and/or a user input interface 68. The user input interface 68, in turn, can comprise any of a number of devices allowing the entity to receive data from a user, such as a microphone, a keypad, a touch display, a joystick or other input device.

In accordance with one embodiment, the computing device 52 can include a DMA controller 69 for communicating, via the communication interface(s) 65, either directly or via the processor 63, with the shared memory, such as that embodied by a mobile terminal 10 in one embodiment. As such the DMA controller 69 of this embodiment includes the means for performing each function described below in conjunction with the hardware element. While the hardware element is embodied in the DMA controller 69 in the embodiment of the computing device 52 of FIG. 4, the hardware element can be comprised of additional or different components, such as the processor 63, configured to directly access the shared memory without intervention of the software element.

Referring again to FIG. 3, the shared memory 74 may be configured to store control data. Such control data may be data regarding a logical structure of the memory and may be designed to synchronize or manage the functionality of the memory 74. For example, the control data may include information about the amount of data stored in the memory 74 and/or the amount of space remaining in the memory 74 to which the hardware element 70 may write new data. The control data may also include information directing the hardware element 70 to a location of the memory 74 to which the hardware element 70 may write data. For example, the control data may include a pointer directing the hardware element 70 to a location of the memory 74 that is capable of storing data. By accessing the control data of the memory 74, the hardware element 70 is thus able to write data to the memory 74 without interacting with the software element 72, for example without executing the computer program code of the software element 72 to request write access to, or a write location of, the memory. In this way, interruption of software element operation may be avoided. For example, an interruption of an operation of the software element to request a write location of the shared memory may add a significant delay considering high data transmission rate operations.

In some embodiments, the software element 72 is configured to update the control data in response to previous alterations to the memory. For example, following a writing operation by the hardware element 70, the software element 72 may be configured to update the control data to include the amount of data that was written by the hardware element 70 in the previous writing operation, the location of the new data, the amount of space left in the memory 74 for additional data, and/or locations in the memory 74 to which data may be written in subsequent writing operations, among other information. In other words, the control data may be updated by the software element 72 to reflect the new or changed logical structure of the memory element 74 as a result of previous writing operations.

In some embodiments, the memory 74 may be partitioned, segmented, or otherwise configured to include a first portion 80 and a second portion 82. The first portion 80 may be configured to enable writing access by at least the software element 72 and the hardware element 70. For example, both the hardware element 70 and the software element 72 may be able to write data to free areas of the first portion 80 (i.e., areas of the first portion that are unrestricted). The second portion 82 may be configured to enable writing access only by the software element 72. The control data may be included in the second portion 82, which may be readable by both the hardware element 70 and the software element 72, but only writable by the software element 72. For example, the software element 72 may be configured to access the second portion 82 and to write control data to the second portion 82 describing one or more locations of the memory 74 to which data may be written. The hardware element 70 may be able to read the control data written by the software element 72 to the second portion 82 in order to identify to which location of the first portion 80 the hardware element 70 is able to write data. Furthermore, as previously mentioned, the memory 74 may be structured such that the hardware element 70 is able to write to the identified location of the first portion 80 without interaction with the software element 72.

The control data may be stored in a single location of the memory 74 or distributed among a plurality of locations of the memory 74, depending on the structure of the memory 74. Likewise, the first and second portions 80, 82 may each be distributed throughout the memory 74. For example, as shown in the embodiment illustrated in FIG. 3, the first portion 80 may be distributed throughout the memory 74 to define a plurality of memory pages 84 (either contiguous or noncontiguous), and the second portion 82 may be distributed to provide corresponding control data for each memory page 84.

In an exemplary embodiment, a block of memory 74 may be allocated as shared memory between a read and write process. The memory block 74 may be any size and may be divided into any number of memory pages 84. For example, the size of the block may be n*2^{k}, where n is the number of memory pages and k is a number chosen to enhance processing efficiency. For example, in FIG. 3, the memory block 74 is divided into 5 memory pages, A-E. At the end of each memory page 84 a number of bytes may be reserved for control data. For example, 8 bytes may be reserved at the end of each memory page—4 bytes for a data registered entry 90 and 4 bytes for a page successor address entry 92, as illustrated in FIG. 5.

In this example, the data registered entries 90 may initially contain the value 0 as no data has yet been written to the associated memory pages 84. As data is written to a memory page 84, the software element 72 may update the control data by modifying the data registered entry 90 to include, for example, the amount of data written to the corresponding memory page 84 or the location on the current memory page 84 to which data may next be written. The page successor address entries 92 may contain the address of the following memory page 84, or the address of the page 84 to which data is to be written when the current memory page data capacity is reached. The hardware element 70 attempting to write data to the memory 74 in this example may initially have data regarding a start address, page size (i.e., 2ⁿ), and an end address and may navigate through the memory pages 84 during any given write process based on the control data associated with each memory page. This initial data may be gathered at the beginning of each write operation, such as by accessing a particular portion of the control data of the memory 74, or the software element 72 may communicate this data to the hardware element 70 at some point, independently of the writing operation, as indicated by the dashed line in FIG. 3 (e.g., following a writing operation).

Thus, in this example, the first and second portions 80, 82 of a memory 74 may be distributed among five memory pages 84 with five corresponding areas of control data, such as A-E shown in FIG. 3. The software element 72 may, in this example, write control data in the second portion 82 corresponding to memory page A directing the hardware element 70 to write to memory page B once memory page A has been filled. Likewise, the software element 72 may write control data in the second portion 82 corresponding to memory page B directing the hardware element 70 to write to memory page C once memory page A has been filled, and so on. In this case, the hardware element 70 may be configured to initially attempt to write data to memory page A. The hardware element 70 may be configured to read the control data in the second portion 82 corresponding to memory page A, which may indicate that memory page A is full and may direct the hardware element 70 to memory page B. If the control data corresponding to page B indicates that there is space on page B, the hardware element 70 may then write data to page B. However, if the corresponding control data indicates that page B, also, is full, then the hardware element 70 may be directed by the control data to the next page to which the hardware element 70 may next attempt to write. In this way, the hardware element 70 may be directed to a memory page that is capable of storing additional data based on the control data without interaction with the software element 72.

In some embodiments, the software element 72 may be executed to write control data to the second portion 82 in response to a writing of data to the first portion 80 by the hardware element 70. Continuing the example above, execution of the software element 72 may, for instance, cause control data corresponding to memory page B to be written (e.g., added or changed) following the writing of data to memory page C by the hardware element 70 that causes memory page C to be full. As a result, instead of directing the hardware element 70 to page C from page B, for example, the control data corresponding to page B may direct the hardware element 70 to continue writing on page E (which may be empty). In this way, the software element 72 may direct a hardware element 70 that is writing data to memory page B in a subsequent writing operation to proceed to memory page E to continue the writing operation once page B has been filled.

In some embodiments, the second portion 82 of the memory 74 may include an indicator 86 indicative of a next location of the first portion 80 of the memory 74 to which the hardware element 70 is able to write during subsequent writing operations. For example, the hardware element 70 may be configured to access the indicator 86 at the beginning of a write operation to identify the location of the memory 74 to which to begin writing data. For instance, if the memory 74 is arranged as memory pages 84, such as in FIG. 3, the indicator 86 may direct the hardware element 70 to a certain page, such as memory page B. If during the writing operation the capacity of memory page B is reached and there is still more data to write, the hardware element 70 may then look to the control data corresponding to memory page B to determine a “next to write” location. In this example, the control data may direct the hardware element to memory page C.

The indicator 86 may be updated, for example by execution of the software element 72 or by similar means. In some cases, the indicator 86 may be updated following each writing operation. The software element 72 may, for example, scan the memory 74 following each writing operation to determine to which location a subsequent writing operation should be directed. For example, if a writing operation, such as the one described in the previous example, results in filling up memory page B (i.e., no additional data can be written to memory page B), the software element 72 may update the indicator 86 so that in a subsequent writing operation the hardware element 70 will be directed to memory page C rather than memory page B (since there is no room left on page B). However, the software element 72 need not update the indicator 86 immediately following a writing operation, but may instead complete any current processing operations before performing the update, rather than interrupting the current processing operations.

Alternatively, the indicator 86 may be updated periodically. For example, the software element 72 may access the control data of the memory 74 to identify required updates of the indicator 86 at regular intervals, such as every millisecond or every 0.5 ms. If an update is identified, such as the one previously described, the software element 72 may update the indicator 86 at that time to reflect the change.

The indicator 86 may be located in the memory 74, such as in part of the second portion 82 of the memory 74 or in another area of the memory 74, distinct from the first and second portions 80, 82, as shown in FIG. 3. Alternatively, the indicator 86 may be located in the hardware element 70, such as in a memory of the hardware element 70. For example, the software element 72 may communicate with the hardware element 70 to populate or update the indicator 86 with data regarding the location of the memory 74 to which the hardware element 70 should attempt to write data during a subsequent writing operation. The software element 72 may, for example, communicate with the hardware element 70 following a writing operation in preparation for a subsequent writing operation and in response to changes in the memory 74 that may have resulted from the previous writing operation. However, interaction of the software element 72 with the hardware element 70 in this case may be independent of the writing operation itself. In other words, it is not necessary for the hardware element 70 to interact with the software element 72 when writing data to the memory 74 because the information directing the hardware element 70 to the appropriate location in the memory 74 to which to write data is already available and accessible to the hardware element 70 via the indicator 86 and the control data of the memory 74. Thus, the software element 72 may interact with the hardware element 70 to update the indicator 86 following alterations to the memory 74 when the software element 72 is not engaged in processing operations that would be interrupted by the interaction, as previously discussed.

Furthermore, the hardware element 70 may be configured to delete data from the memory 74, or write new data over data that is already stored in the memory 74 but that is no longer needed. As previously discussed in the context of other writing operations, the hardware element 70 may access control data to identify locations of the memory 74 storing data to be deleted. The hardware element 70 may then delete the data, and the control data may be updated accordingly in response. For example, following a delete operation in which 80 bytes of data were removed, the software element 72 may access control data corresponding to the portion of the memory 74 affected and update the control data to reflect the deletion. The software element 72 may thus, for example, increase the record of the number of bytes available to be written to the corresponding portion of the memory 74 by 80 bytes.

In another example, data written to a particular location of the memory 74, such as on a particular memory page 84, may be “registered” by the hardware element 70 or by the software element 72, for example through a notation in the corresponding control data by the software element 72 following the writing operation. Such a registration of data may indicate that the registered data may not be overwritten by a subsequent writing operation. For example, a memory page 84 containing registered data may not be referenced by the indicator 86 or other control data as a page 84 that is available to the hardware element 70 to write upon. As the registered data becomes obsolete (e.g., obsolete protocol headers), or is no longer needed, the data may be “deregistered,” such as by removing or changing the notation in the control data. For example, the data may be deregistered by the hardware element 70, such as in response to an action by a user, or by the software element 72, for example after scanning the memory pages 84 and finding obsolete data. When data is deregistered, the corresponding part of the memory 74 may once again become available for subsequent writing operations by the hardware element 70. Thus, the deregistered page 84 may, for example, be included in control data providing a “next to write” location. In this way, the unnecessary/obsolete data may be overwritten with new data without physical deletion of the old data prior to the writing of the new data.

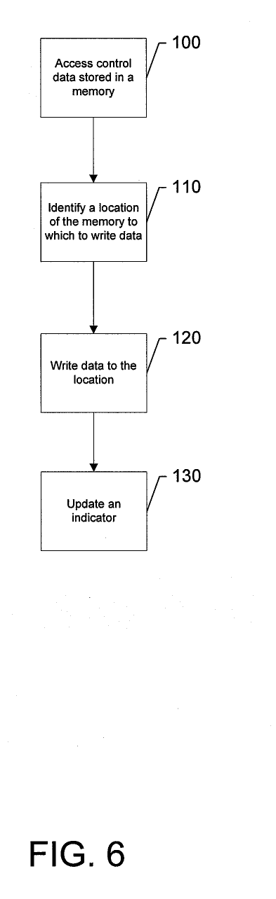

FIG. 6 is a flowchart of a method and computer program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing management of shared memory for concurrent access is provided. Referring to FIG. 6, control data stored in a memory that is accessible to at least a hardware element and a software element is accessed, for example by the hardware element. Based on the control data, a location of the memory to which the hardware element is able to write data is identified. Data is then written to the identified location, e.g., by the hardware element, without interaction with the software element. FIG. 6, blocks 100-120.

As previously discussed, the control data may include logical information pertaining to the structure of the memory and the location of data in the memory. Thus, accessing the control data may include accessing logical information disposed in a single location of the memory to identify at least one portion of the memory to which the hardware element can write. Alternatively, the logical information may be distributed among a number of locations of the memory, and accessing the control data may include accessing logical information from one or more of the distributed locations to identify at least a portion of the memory to which the hardware element can write.

In some embodiments, logical information included in the control data that has been updated by the software element in response to previous alterations to the memory may be accessed. For example, a previous writing operation or other alteration to the memory may have resulted in a certain area of the memory being unable to store additional information. As a result, the software element may have updated the logical information to reflect this fact, and accessing the control data would in turn access this updated logical information.

Furthermore, an indicator indicative of a next location of the memory to which the hardware element is able to write during subsequent writing operations may also be updated, as shown in block 130. The indicator may provide, for example, a location of the memory to which the hardware element may attempt to write data during a subsequent writing operation, as previously discussed. The indicator may be accessible to at least the hardware element and the software element.

In addition, the indicator may be included in the memory itself, or the indicator may be in a separate memory of the hardware element. For embodiments in which the indicator is part of the hardware element, updating the indicator may include copying at least a portion of the control data to the hardware element. For example, the software element may, following a writing operation, communicate with the hardware element to update the indicator with the location of the memory to which the hardware element may write data during a subsequent writing operation. However, as previously described, such interaction may be independent of the writing operation itself, and the indicator may be updated at a time during which the software element is not involved in a processing activity or operation that would be interrupted by the update.

In some embodiments, writing data (block 120) includes deleting data from the memory. For example, the hardware element may delete data from the memory that is no longer needed and write new data, either during the same writing operation or a subsequent writing operation, to the locations in the memory from which data was deleted. The control data may then be updated to reflect areas of the memory that may have become available to store additional data as a result of the deletion. Similarly, obsolete data or data that is no longer needed may be “deregistered,” as previously discussed, and may be overwritten with new data.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
accessing, using a hardware element, control data stored in a memory that is accessible to at least the hardware element and a software element;
identifying, based on the control data, a location of the memory to which the hardware element is able to write data; and
writing data to the identified location from the hardware element without interaction with the software element while writing data to the identified location.

2. The method of claim 1, wherein accessing the control data comprises accessing logical information distributed among a plurality of locations of the memory to identify at least one portion of the memory to which the hardware element is able to write data.

3. The method of claim 1, wherein accessing the control data comprises accessing logical information disposed in a single location of the memory to identify at least one portion of the memory to which the hardware element is able to write data.

4. The method of claim 1, wherein accessing the control data comprises accessing logical information that has been updated by the software element in response to previous alterations to the memory.

5. The method of claim 1 further comprising updating an indicator indicative of a next location of the memory to which the hardware element is able to write during subsequent writing operations, wherein the indicator is accessible to at least the hardware element and the software element.

6. The method of claim 5, wherein updating the indicator comprises copying at least a portion of the control data to the hardware element.

7. The method of claim 1, wherein writing data comprises deleting data from the memory.

8. A computer program product comprising at least one computer-readable storage medium having computer-readable program code portions stored therein, the computer-readable program code portions comprising:
a first executable portion for accessing control data stored in a memory that is accessible to at least a hardware element and a software element;
a second executable portion for identifying, based on the control data, a location of the memory to which the hardware element is able to write data; and
a third executable portion for writing data to the identified location from the hardware element without interaction with the software element.

9. The computer program product of claim 8, wherein the first executable portion is further configured to access logical information distributed among a plurality of locations of the memory to identify at least one portion of the memory to which the hardware element can write.

10. The computer program product of claim 8, wherein the first executable portion is further configured to access logical information disposed in a single location of the memory to identify at least one portion of the memory to which the hardware element can write.

11. The computer program product of claim 8, wherein the first executable portion is further configured to access logical information that has been updated by the software element in response to previous alterations to the memory.

12. The computer program product of claim 8 further comprising a fourth executable portion configured to update an indicator indicative of a next location of the memory to which the hardware element is able to write during subsequent writing operations, wherein the indicator is accessible to at least the hardware element and the software element.

13. The computer program product of claim 12, wherein the fourth executable portion is further configured to copy at least a portion of the control data to the hardware element.

14. The computer program product of claim 8, wherein the third executable portion is further configured to delete data from the memory.

15. An apparatus comprising a shared memory including:
a first portion configured to enable writing access by at least a software element and a hardware element; and
a second portion configured to enable writing access only by the software element, wherein the second portion includes control data readable by the hardware element for directing the hardware element to which location of the first portion of the memory the hardware element is able to write data without interaction with the software element.

16. The apparatus of claim 15, wherein the apparatus comprises the software element stored in the memory and configured, upon execution, to write control data to the second portion in response to the hardware element writing data to the first portion.

17. The apparatus of claim 15, wherein the first and second portions are each distributed throughout the memory.

18. The apparatus of claim 17, wherein the first portion is distributed throughout the memory to define a plurality of memory pages and the second portion is distributed to provide corresponding control data for each memory page.

19. The apparatus of claim 15, wherein the second portion further comprises an indicator indicative of a next location of the first portion of the memory to which the hardware element is able to write during subsequent writing operations.

20. The apparatus of claim 19, wherein the indicator is updated following each writing operation.

21. The apparatus of claim 19, wherein the indicator is updated periodically.

22. An apparatus comprising:
a hardware element including a processor configured to access control data stored in a memory identifying a location in the memory to which to write data;
wherein the hardware element is configured to write data to the identified location of the memory that is accessible to at least the hardware element and a software element without interaction with the software element while writing data to the identified location.

23. The apparatus of claim 22, wherein the hardware element comprises a Direct Memory Access (DMA) controller.

24. The apparatus of claim 22, wherein the hardware element is configured to access an indicator including at least a portion of the control data indicative of a next location of the memory to which the hardware element is able to write.

25. An apparatus comprising:
means for accessing control data stored in a memory that is accessible to at least a hardware element and a software element;
means for identifying, based on the control data, a location of the memory to which the hardware element is able to write data; and
means for writing data to the identified location from the hardware element without interaction with the software element while writing data to the identified location.

26. The apparatus of claim 25 further comprising means for updating an indicator indicative of a next location of the memory to which the hardware element is able to write during subsequent writing operations, wherein the indicator is accessible to at least the hardware element and the software element.

27. A system comprising:
a hardware element;
a software element configured, upon execution, to communicate with the hardware element; and
a memory configured to store control data and configured to be accessible to at least the hardware element and the software element;
wherein the hardware element is configured to access the control data, to identify, based on the control data, a location of the memory to which to write data, and to write data to the identified location without interaction with the software element while writing data to the identified location.

28. The system of claim 27, wherein the hardware element comprises a Direct Memory Access (DMA) controller.

29. The system of claim 27, wherein the hardware element is configured to access control data distributed among a plurality of locations of the memory.

30. The system of claim 27, wherein the hardware element is configured to delete data from the memory.

31. The system of claim 27, wherein the software element is configured, upon execution, to update the control data in response to previous alterations to the memory.

32. The system of claim 27, wherein the software element is configured, upon execution, to update an indicator indicative of a next location of the memory to which the hardware element is able to write during subsequent writing operations, and wherein the indicator is accessible to the hardware element.
